(19) United States
(12) Patent Application Publication
(10) Pub. No.: US 2014/0370904 A1
(43) Pub. Date: Dec. 18, 2014

(54) DEVICE-TO-DEVICE DISCOVERY

(71) Applicant: RESEARCH IN MOTION LIMITED, Waterloo (CA)

(72) Inventors: Jack Anthony Smith, Valley View, TX (US); Masoud Ebrahimi Tazeh Mahalleh, Ottawa (CA); Robert Novak, Stittsville (CA); Robert Mark Harrison, Grapevine, TX (US); JoonBeom Kim, Carrolton, TX (US)

(21) Appl. No.: 13/915,641

(22) Filed: Jun. 12, 2013

(51) Int. Cl. H04W 76/02

(52) U.S. Cl. CPC H04W 76/021
USPC 455/450

(57) ABSTRACT

A wireless access network node assigns different base sequences to respective user equipments (UEs) to use for discovery beacon signals for device-to-device (D2D) discovery.

### BACKGROUND

User equipments (UEs) can communicate with each other in a mobile communications network. Traditionally, UEs can establish wireless connections with wireless access network nodes of the mobile communications network. Once the wireless connections are established, data can be exchanged between the UEs and wireless access network nodes, and the wireless access network nodes can transmit the data to respective destination UEs.

A different type of wireless communication between UEs involves device-to-device (D2D) communication. In a D2D communication, UEs that are sufficiently close in proximity to each other can send data directly to each other, without first sending the data to a wireless access network node. The establishment of a D2D link between UEs can be controlled by one or more wireless access network nodes.

### BRIEF DESCRIPTION OF THE DRAWINGS

Some embodiments are described with respect to the following figures:

FIG. 1 is a schematic diagram of sequences produced by cyclic shifting of a base sequence.

FIG. 2 is a schematic diagram of an example network arrangement, according to some implementations.

FIGS. 3A-3D illustrate example discovery beacon signals.

FIGS. 4A-4B illustrate example power delay profiles in different cyclic shift time regions, from the perspective of a wireless access network node and a user equipment (UE), respectively, according to some examples.

FIG. 5 is a flow diagram of a process of a wireless access network node for assigning base sequences to use for beacon signals for device-to-device (D2D) discovery, according to some implementations.

FIG. 6 illustrates a Physical Random Access Channel (PRACH) region allocated for discovery beacon signals, according to some implementations.

FIG. 7 illustrates symbols for an example Physical Uplink Control Channel (PUCCH) format.

FIG. 8 is a flow diagram of controlling a power level for discovery beacon signal transmissions, according to some implementations.

FIG. 9 is a schematic diagram of an example of transmitting a discovery beacon signal between UEs in different cells, according to some implementations.

FIG. 10 is a flow diagram of a UE interference measurement process, according to some implementations.

FIG. 11 is a block diagram of a UE and a wireless access network node, according to some implementations.

### DETAILED DESCRIPTION

Various techniques can be used to multiplex signals transmitted wirelessly between user equipments (UEs) and a wireless access network node. Examples of UEs include mobile telephones, smartphones, personal digital assistants, tablet computers, notebook computers, gaming devices, and other electronic devices.

Multiplexing signals refers to combining the signals onto a shared medium between transmitting devices and receiving devices. The multiplexed signals are placed in separate logical or physical resources to allow a recipient to be able to detect a corresponding one of the signals. For example, signals for different UEs can be transmitted in different time resources (e.g. time slots) or frequency resources (e.g. different subcarriers), or different combinations of time and frequency resources. By separating signals associated with different UEs in different time and/or frequency resources, a receiver is able to distinguish between signals associated with different UEs.

Alternatively, multiplexing of signals associated with different UEs can be based on use of Zadoff-Chu sequences. A Zadoff-Chu sequence, when applied to a signal, gives rise to an electromagnetic signal of constant amplitude. A root or base Zadoff-Chu sequence can be cyclically shifted to produce cyclically-shifted versions of the base sequence. Cyclically shifting a sequence refers to time shifting the sequence by a specified amount, and moving an end portion of the sequence to the front of the cyclically-shifted sequence.

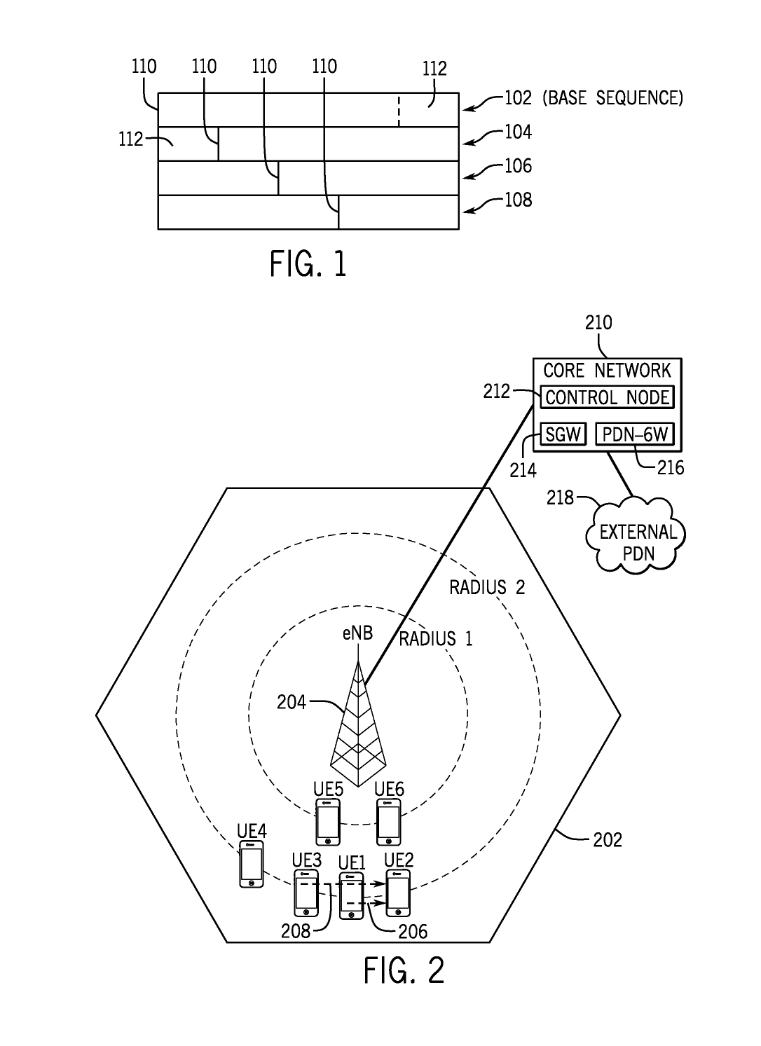

FIG. 1 shows an example of cyclic shifts applied to a base sequence 102 to produce three other cyclically-shifted sequences 104, 106, and 108. To produce the first cyclically-shifted sequence 104, the leading edge 110 of the base sequence 102 is time shifted to the right by a specified amount, to result in the leading edge 110 being shifted in the cyclically-shifted sequence 104. An end portion 112 of the base sequence 102 is moved (cycled) to the front portion of the cyclically-shifted sequence 104. Further cyclic shifting results in cyclically-shifted sequences 106 and 108, which show the leading edge 110 of the base sequence 102 being shifted further to the right.

A Zadoff-Chu sequence has both an ideal cyclic autocorrelation property and an ideal cyclic cross-correlation property. The ideal cyclic autocorrelation property means that there is zero cyclic autocorrelation for time shifts other than a zero time shift, which provides for the ability to generate multiple orthogonal sequences from the same base sequence by using cyclic shifting of the base sequence, as depicted in FIG. 1. Sequences that are orthogonal to each other do not interfere with each other. In the example of FIG. 1, the sequences 102, 104, 106, and 108 are orthogonal to each other due to the ideal cyclic cross-correlation property.

The ideal cyclic cross-correlation property implies that the interference between two different Zadoff-Chu sequences is minimum and constant for different time shifts.

In a wireless access network, such as a Long-Term Evolution (LTE) wireless access network, sequences based on Zadoff-Chu sequences can be employed for producing various different signals, including signals of a Physical Random Access Channel (PRACH), a Sounding Reference Signal (SRS), and signals of a Physical Uplink Control Channel (PUCCH). Zadoff-Chu sequences can also be used for other signals.

The PRACH is used for performing a random access procedure, which is initiated by a UE to associate itself with a wireless access network node, and to acquire resources for communicating with the wireless access network node. A PRACH signal can also be used by a wireless access network node to determine a round-trip propagation delay between the wireless access network node and a UE. This round-trip propagation delay can be used by the wireless access network node to determine timing advance values for the UEs the wireless access network node serves. The timing advance values for the UEs control the timing of the UEs' uplink transmissions such that they are sufficiently well synchronized to avoid mutual interference when received by the wireless access network node. The timing advance value is sometimes referred to as the timing alignment value, and these terms refer to the same value in this document.

An SRS is transmitted by a UE, and is monitored by a wireless access network node for determining uplink channel quality, to determine a timing advance value to be used by the UE, and for other tasks. The PUCCH is an uplink control channel that can be used to send certain control signaling, including a Channel Quality Indication (CQI) which indicates a current channel condition as seen by the UE, ACK/NAK (to provide positive or negative acknowledge of data received on the downlink), and so forth.

Although reference is made to specific signaling, it is noted that implementations can be applied to other types of signaling in other examples.

In the ensuing discussion, reference is made to mobile communications networks that operate according to the LTE standards as provided by the Third Generation Partnership Project (3GPP). The LTE standards are also referred to as the Evolved Universal Terrestrial Radio Access (E-UTRA) standards.

Although reference is made to E-UTRA in the ensuing discussion, it is noted that techniques or mechanisms according to some implementations can be applied to other wireless access technologies. For example, such other wireless access technologies can include the Universal Mobile Telecommunications System (UMTS) technology, which is also referred to as the Universal Terrestrial Radio Access (UTRA), or another type of wireless access technology.

In an E-UTRA network, a wireless access network node is referred to as an enhanced Node B (eNB). An eNB can include functionalities of a base station and base station controller. The ensuing discussion refers to eNBs. In other examples, techniques or mechanisms according to some implementations can be applied to other types of wireless access network nodes.

Traditionally, a PRACH signal, an SRS, and a PUCCH signal are transmitted by a UE to an eNB. However, with the advent of device-to-device (D2D) technology, these signals can be considered for use as beacon signals to allow for device discovery in the D2D context. Device discovery allows a first UE to discover the presence (and proximity) of a second UE. However, when signals traditionally sent by a UE to an eNB are used as discovery beacon signals, then various issues may arise.

A first of the issues is multiplexing ambiguity, where multiplexing based on use of cyclically-shifted Zadoff-Chu sequences may fail in transmissions between UEs for D2D discovery. A second of the issues relate to power control of signals used for D2D discovery. Other issues are discussed further below.

Cyclic Shift Multiplexing Ambiguity

FIG. 2 illustrates an example scenario in which six UEs (UE1, UE2, UE3, UE4, UE5, and UE6) are located within a cell 202 served by an eNB 204. The eNB 204 is connected to a core network 210 of the mobile communications network (E-UTRA network in the described examples). The core network 210 includes a control node 212, which in an E-UTRA network is a mobility management entity (MME). An MME performs various control tasks associated with an E-UTRA network. For example, the MME can perform idle mode UE tracking and paging, bearer activation and deactivation, selection of a serving gateway (discussed further below) when the UE initially attaches to the LTE network, handover of the UE between macro eNBs, authentication of a user, generation and allocation of a temporary identity to a UE, and so forth. In other examples, the MME can perform other or alternative tasks.

In an E-UTRA network, the core network 210 can also include a serving gateway (SGW) 214 and a packet data network gateway (PDN-GW) 216. The SGW 214 routes and forwards traffic data packets of a UE served by the SGW 214. The SGW 214 can also act as a mobility anchor for the user plane during handover procedures. The SGW 214 provides connectivity between the UE and the PDN-GW 216. The PDN-GW 216 is the entry and egress point for data communicated between a UE in the E-UTRA network and a network element coupled to an external packet data network (PDN) 218. Note that there can be multiple PDNs and corresponding PDN-GWs. Moreover, there can be multiple MMEs and SGWs in the core network 210. In addition, although just one cell 202 is depicted in FIG. 2, there can be multiple cells with respective eNBs.

In the cell 202, UE5 and UE6 are located generally at a first distance (radius 1) from the eNB 204, while UE1-UE4 are located generally at a second distance (radius 2) from the eNB 204.

The eNB 204 can instruct a UE to transmit a discovery beacon signal targeted at another UE. For example, the eNB 204 can instruct both UE1 and UE3 to transmit respective discovery beacon signals targeted at UE2. The eNB 204 can instruct UE2 to perform measurement of the discovery beacon signal transmitted by each of UE1 and UE3, and UE2 can report the measurement of the discovery beacon signals back to the eNB 204.

In some implementations, the UEs in the cell 202 operate in network-assisted mode (where the eNB 204 assists in the control of UEs for D2D communications). As a result, it can be assumed that the UEs in the cell 202 are generally time-aligned with respect to the serving eNB 204, based on timing advance values transmitted by the eNB 204 to the respective UEs. Because UE1 and UE3 are generally at an equal distance from the eNB 204, their timing advance values would be set to the same value by the eNB 204. By using the same timing advance values at UE1 and UE3, signals sent by UE1 and UE3 can be expected to arrive at the eNB 204 in specified time intervals.

In one example, it is assumed that UE1 and UE3 are instructed by the eNB 204 to transmit beacon signals (for D2D discovery) using two different cyclic shifts of the same base sequence, such as a base sequence for an SRS. In other examples, UE1 and UE3 can transmit discovery beacon signals using base sequences for other control signals, such as PRACH and PUCCH signals. More specifically, assume that UE3 is instructed to use cyclic shift 4 while UE1 is instructed to use cyclic shift 5 when constructing their respective SRS sequences. Cyclic shift n, where n is an integer, refers to performing a cyclic shift of the base sequence by n specified shift time intervals.

Because UE1 and UE3 are time-aligned with respect to the eNB 204, the two SRS sequences transmitted by UE1 and UE3 are orthogonal from the point of view of the eNB 204. However, UE2 operates from a different point of reference when compared to the eNB 204, and the time alignment that is created at the eNB 204 does not hold true at UE2's location. This is illustrated in FIG. 2 by the two dashed lines 206 and 208 connecting UE2 to UE1 and UE3, respectively. Note that the timing advance values are set equal for UE1 and UE3 by the eNB 204, since UE1 and UE3 are generally equidistant to the eNB 204. As a result, both UE1 and UE3 perform transmissions of their respective beacon signals synchronously in time.

However, the lines 206 and 208 illustrate that the propagation distance between UE3 and UE2 is larger than that between UE1 and UE2. Thus, the beacon signal transmission from UE3, which is transmitted synchronously with the beacon signal transmission from UE1, will arrive at UE2 delayed in time with respect to the beacon signal transmission from UE1. Because the beacon signal transmission of UE1 is a cyclically-shifted version of the beacon signal transmission of UE3, there exists a distance between UE1 and UE3 where the beacon signal transmission of UE3 will be delayed by the right amount so that a large portion of UE3's beacon signal is indistinguishable from the beacon signal transmission of UE1, from the point of view of UE2. In a specific example, if the distance between UE3 and UE1 is such that the signal from UE3 undergoes an additional propagation time of 1/16 of a symbol time interval, then the signals are indistinguishable and UE2 may determine that it was receiving the beacon signal transmission of UE1 even though UE3 had performed the transmission.

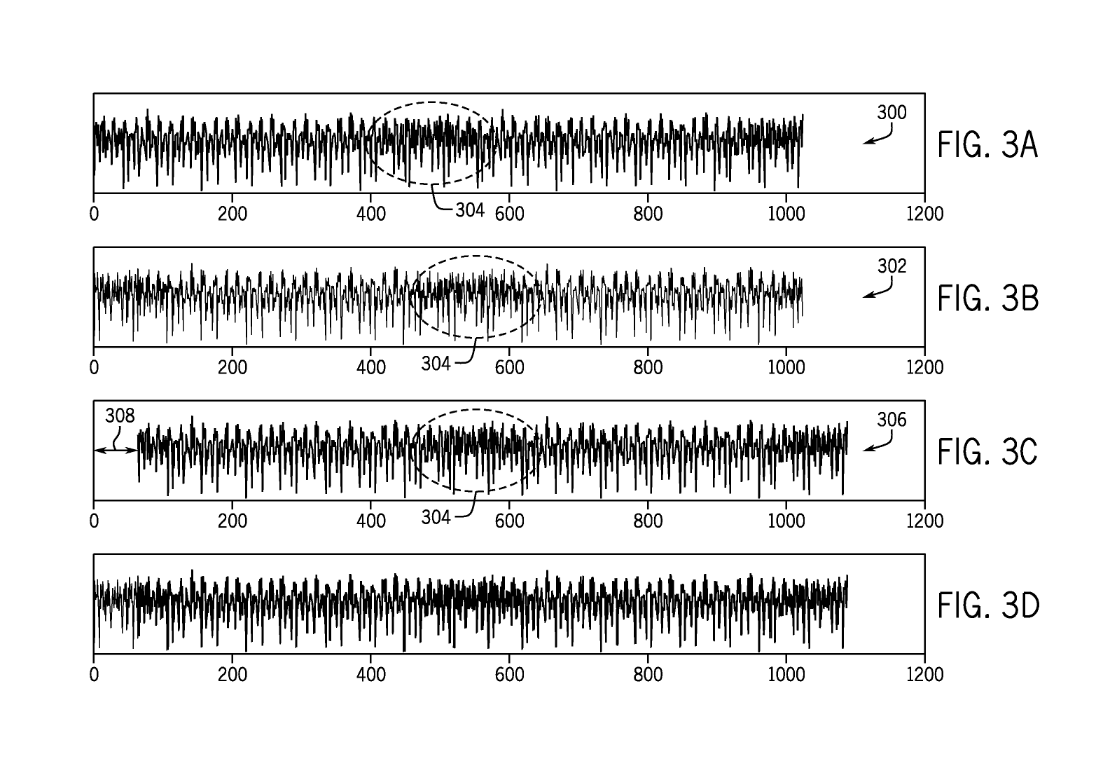

An example of the foregoing issue is illustrated in FIGS. 3A-3D. FIG. 3A shows an SRS sequence 300 having a first cyclic shift. FIG. 3B shows a second SRS sequence 302 that has a second cyclic shift that is different from the first cyclic shift. As depicted in FIGS. 3A and 3B, a darker portion 304 in the sequence 300 is shifted to the right in the sequence 302.

FIG. 3C shows a delayed version 306 of the sequence 300, due to a propagation delay between the transmitting UE and the receiving UE. The amount of delay is represented as 308 in FIG. 3C. Due to the propagation delay, large parts (including the portion 304) of the sequence 302 and the delayed version of 306 of the sequence 300 become time aligned and look the same to the receiving UE2. In this case, false detection can occur at UE2.

FIG. 3D shows the summation of sequence 302 and the delayed version 306 of the sequence 300, to illustrate how large parts of these sequences look the same.

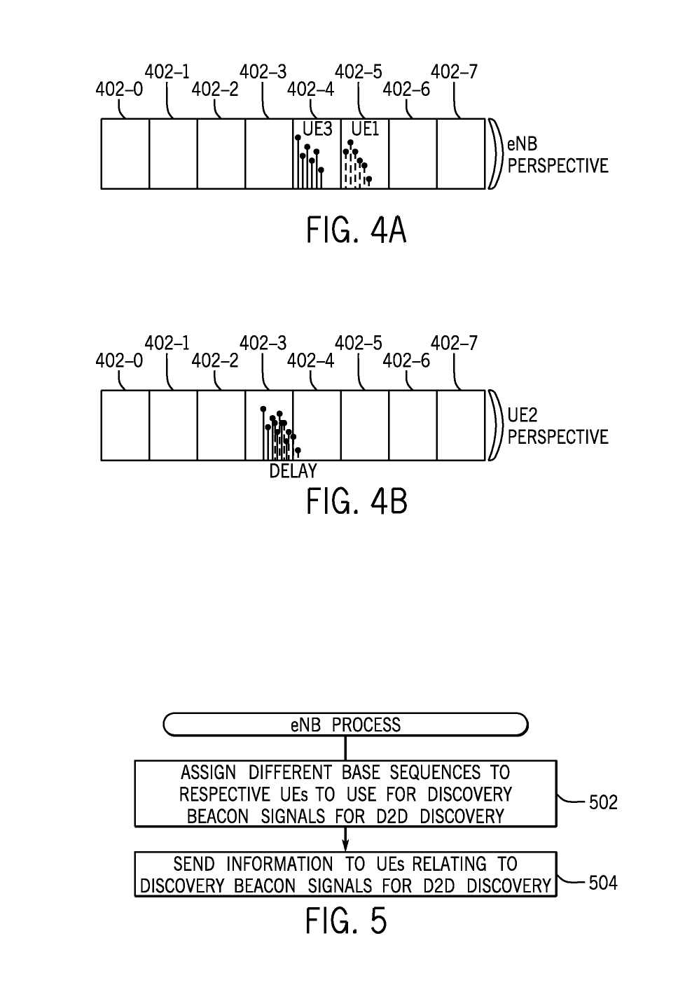

Another way of visualizing the foregoing issue is shown in FIGS. 4A and 4B. Each of FIGS. 4A and 4B plots magnitude versus delay (with delay quantized to delay bins) and show cyclic shift time regions 402-0 to 402-7 that correspond to respective different cyclic shifts. For example, time region 402-4 corresponds to cyclic shift 4, whereas time region 402-5 corresponds to cyclic shift 5.

A power delay profile corresponding to a signal transmission by UE3 is depicted in time region 402-4 in FIG. 4A, and a power delay profile for a signal transmission by UE1 is depicted in time region 402-5 in FIG. 4A. A power delay profile includes rays representing various versions of a signal transmitted by the corresponding UE. The first ray in the power delay profile represents the direct signal that propagated directly from the UE to the receiver. Within a cell, there can be various obstructions and reflectors (e.g. buildings, etc.) that can cause delayed versions of the signal to arrive at the receiver. The delay is due to propagation delay of the transmitted signal due to presence of one or more obstructions, which can cause reflection of the signal that is received by the receiver.

As depicted in FIG. 4A, from the perspective of the eNB 204, the power delay profiles of signals transmitted by UE3 and UE1 show up in the expected cyclic shift time regions 402-4 and 402-5, since the eNB 204 has time-aligned UE3 and UE1 with respect to the eNB 204.

However, from the perspective of UE2, as shown in FIG. 4B, the two power delay profiles have shifted left because of the closer proximity of UE3 and UE1 to UE2. However, UE1 is closer to UE2 than UE3, such that the power delay profile for UE1 is shifted even further to the left, which can cause the two power delay profiles to become un-resolvable at UE2 as shown in FIG. 4B.

If UE1 had been blocked from UE2 by a building or other obstruction such that UE1's power delay profile is below a measurement threshold, then false detection can occur if even one of UE3's rays arrives in the detection window, and this ray is above the measurement threshold. Also, even if UE3 does not transmit a discovery beacon signal or is blocked from UE2 by an obstruction, because the detected power delay profile at UE2 mostly falls in cyclic shift time region 402-3, UE2 will report to the eNB 204 that UE1 was not detected (since UE1 was expected to have a cyclic shift 5). As a result, missed detection can occur.

The receiving UE, which in this example is UE2, processes received samples (which can include the rays of the power delay profile shown in FIG. 4B, for example) by performing the following for each UE antenna: UE2 removes a cyclic prefix, multiplies the resulting value by a complex conjugate of the assumed transmitted sequence, and then computes an inverse fast Fourier transform (IFFT) of the result. Next, UE2 combines each delay bin across the antennas by summing the squared magnitudes from each of the antennas of UE2. The detection window is set by UE2, and if any of the detected peaks in the detection window violates (i.e. exceeds) a threshold that is a function of the number of antennas, then a detection is assumed (the detection can be a true or false detection).

Note that some algorithms may discard the last few samples in a detection window if it is assumed that the delay spread is constrained to a certain duration. Note that in current processing algorithms at the eNB, the eNB has the ability to substantially narrow the detection window by taking into account what the maximum delay spread should be, which helps to reduce false detections. However, in the D2D context, because the detection window cannot be set as precisely as that done by the eNB (due to the unknown propagation delay between the transmitting UE and the receive UE), false detections are more of an issue in D2D.

In the absence of any additional information from the eNB, UE2 can assume that UE1 is nearby and can use its current value of timing alignment to set the detection window. In other words, UE2 can assume that UE1 is right next to UE2 and so they are operating synchronously. Note that the eNB can provide information that UE2 can use to improve the location of the detection window when the two UEs are at different distances from the eNB. In this latter case, the eNB can signal the timing alignment value of UE1 to UE2, and UE2 can move the detection window correspondingly based on UE2's own timing alignment value.

Mitigation Solutions for Cyclic Shift Multiplexing Ambiguity When Using SRS for D2D Discovery Beacon Signal

In accordance with some implementations, the cyclic shift multiplexing ambiguity issue for an SRS used as a discovery beacon signal can be addressed using a process as depicted in FIG. 5. The process of FIG. 5 can be performed by the eNB 204. The eNB 204 assigns (at 502) different base sequences to respective UEs to use for discovery beacon signals (e.g. SRS) for D2D discovery. Although reference is made to use of SRS as a discovery beacon signal, it is noted that the FIG. 5 technique can also be applied to other types of discovery beacon signals, such as PUCCH signals or PRACH signals, as discussed further below.

The eNB 204 also sends (at 504) information to designated UEs served by the eNB 204 that are involved in D2D discovery, where the information includes parameters relating to discovery beacon signals for D2D discovery. Examples of parameters are discussed further below.

Traditionally, UEs that transmit an SRS within a cell (for reception by an eNB) perform the transmissions of the SRS using the same base sequence to achieve orthogonality of the SRS transmissions in the cell. However, as noted above in connection with FIG. 5, different base sequences can be assigned to UEs for SRS transmissions for use as D2D discovery beacon signals (also referred to as beacon transmissions).

In some implementations, beacon-transmitting UEs (UEs that transmit D2D discovery beacon signals) can be isolated in a specified set of time-frequency resources. Stated differently, beacon-transmitting UEs are allocated by the eNB 204 to use a first set of time-frequency resources for SRS transmissions, while non-beacon transmitting UEs (those UEs that do not transmit D2D discovery beacon signals) are allocated by the eNB 204 to use a second, different set of time-frequency resources for normal SRS transmissions that are detected by the eNB 204.

As a specific example, the first set of time-frequency resources can include a first comb (also referred to as “frequency comb”), while the second set of time-frequency resources can include a second comb. The different combs include different corresponding sets of subcarriers. For example, a first set of subcarriers of the first comb can include even numbered subcarriers (this comb is referred to as an “even comb”), while a second set of subcarriers of the second comb can include the odd numbered subcarriers (this comb is referred to as an “odd comb”). Other types of combs can be formed in other examples.

By isolating beacon-transmitting UEs from non-beacon transmitting UEs on different sets of time-frequency resources, the negative impact of using different base sequences for SRS transmissions can be reduced. An SRS transmitted as a discovery beacon signal would have no impact on an SRS transmitted by a non-beacon-transmitting UE, since the two SRS are isolated on different time-frequency resources. Moreover, because discovery beacon reception can be more robust than receiving a signal for the purpose of channel state estimation, the impact of an SRS transmitted as a discovery beacon signal on other beacon-transmitting UEs should be relatively small since the SRS used as beacon-transmitting signals are not being monitored for gathering channel state information, but simply to determine whether one UE is located close to another UE.

In addition, many of the beacon transmissions (D2D discovery beacon signals) on different base sequences may occur in different parts of a cell and may be attenuated by the time these beacon transmissions reach a given UE, which helps to mitigate interference. The few UEs that are in the vicinity of a given UE may be largely uncorrelated due to the correlation properties of Zadoff-Chu sequences.

Additionally, with respect to the impact beacon transmissions in one cell have on adjacent cells, it is noted that adjacent cells traditionally use different base sequences for SRS transmissions, and thus eNBs already have mechanisms in place to mitigate the impact of SRS transmissions between adjacent cells.

In some implementations, the assignment of base sequences to cells can be performed in a way that the same base sequence is not used by two adjacent cells. Traditionally, there can be a one-to-one mapping between a cell identifier and a base sequence index (which identifies a base sequence). In accordance with some implementations, this one-to-one mapping can be modified to a one-to-many mapping that assigns multiple base sequence indexes to a single cell identifier. The number of base sequences assigned to each cell may be configurable by upper protocol layers, or may be coordinated among cells.

There are scenarios where beacon transmissions in one cell can have some impact on performance in an adjacent cell. For example, if the adjacent cell is performing interference cancellation of the SRS sequences, then the interference cancellation for measured SRS transmissions may be impacted. Interference cancellation involves eNBs notifying each other of base sequences used for SRS transmissions in the respective cells. An eNB in a first cell is notified of the base sequence for an SRS in a second, adjacent cell. The first cell eNB can use this knowledge to perform interference cancellation of an SRS measured by the first cell eNB. In some implementations, the impact on interference cancellation can be reduced by sharing lists of base sequences used for beacon SRS transmissions among adjacent cells.

Additionally, when a UE is in a cell-edge region (near the boundary between two cells), the D2D UEs transmitting SRS associated with different cells may mutually interfere. To address the foregoing issue, eNBs of adjacent cells can coordinate resources for use as discovery beacon signals, such that discovery beacon signals are sent in the same resources (e.g. same subframe, comb, etc.).

In further implementations, to mitigate cyclic shift multiplexing ambiguity, the number of frequency combs used for SRS transmissions can be increased. Each comb includes a distinct set of subcarriers. In some examples, multiple combs can be formed from a particular comb (e.g. even comb or odd comb). For example, the particular comb can include a first set of subcarriers. Multiple combs can be derived from the particular comb by selecting subsets of subcarriers from the first set of subcarriers for the respective different multiple combs. Forming multiple combs from the particular comb (e.g. even comb) preserves backward-compatibility to allow other UEs (e.g. non-beacon transmitting UEs) to use a different comb (e.g. odd comb). State differently, in the foregoing example, multiple combs can be derived from the even comb to use for beacon SRS transmissions. However, the odd comb is not affected, and can be used for non-beacon SRS transmissions to preserve backward compatibility when using the odd comb.

As noted above, various types of parameters can be signaled (task 504 in FIG. 5) from the eNB 204 to UEs involved in D2D discovery to assist the UEs in placing their detection windows (for detecting discovery beacon signals). Relative timing advance information (such as a difference between a timing advance value of a first UE and a timing advance value of a second UE) can provide a receiving UE with information that allows the receiving UE to set its detection window more precisely. Also, a maximum delay spread can be signaled to a UE. The maximum delay spread specifies a range of delays that may occur in the communication of a discovery beacon signal from a transmitting UE to a receiving UE. A delay spread is a measure of the difference between the time of arrival of an earliest significant multipath component (e.g. the first ray of the power delay profile in FIG. 4A or 4B) and the time of arrival of the latest multipath component (e.g. the last ray of the power delay profile in FIG. 4A or 4B).

The receiving UE can use the maximum delay spread to use only some portion of the detection window. In some examples, the maximum delay spread may be signaled by the eNB 204 to the receiving UE if the eNB 204 anticipates that a neighboring cyclic shift may encroach slightly into the target detection window.

In more specific examples, the eNB 204 can notify a UE of one or more of the following parameters:
Base sequence index (to identify a base sequence of the discovery beacon signal);
Cyclic shift spacing (the length of each cyclic shift time region, such as those depicted in FIG. 4B);
Cyclic shift index (to identify a cyclic shift applied to the base sequence of the beacon transmission);
Number of frequency combs (to identify the number of combs that are useable for beacon transmissions);
Index of legacy comb that is being subdivided into additional combs (to identify the legacy comb, such as the even or odd comb discussed above, from which multiple combs are derived);
Comb index (to identify the comb, from among multiple possible combs, used for a given beacon transmission);
Timing advance of a transmitting UE;
Timing advance of a receiving UE;
Maximum delay spread that should be expected by a receiving UE;
Time resources of beacon transmission; and
Frequency resources of beacon transmission.

Mitigation Solutions for Cyclic Shift Multiplexing Ambiguity When Using PRACH for D2D Discovery Beacon Signal

In alternative implementations, when PRACH signals are used as discovery beacon signals for D2D discovery, cyclic shift multiplexing ambiguity can also be present. However, a PRACH signal generally has a much longer duration than the duration of an SRS, since the PRACH signal is to be used for determining a round-trip delay time between an eNB and a UE. The length of the PRACH signal determines the largest cell size that is supported.

A signal that can be communicated in the LTE PRACH is a preamble. A preamble includes a specific pattern or signature. Different preambles can be used to differentiate random access requests from different UEs. However, if two UEs use the same preamble at the same time, then a collision may occur. A preamble is the first signal sent by a UE to initiate a random access procedure, which is performed by a UE to associate itself with and to acquire resources in the network.

Within a cell, a specified number of preambles (e.g. 64 preambles in an E-UTRA network) can be used. The specified number of preambles can be divided into a first set and a second set, where the first set of preambles is used for contention-free random access procedures, and a second set of preambles is used for contention-based random access procedures. Since each UE is using a shared communication medium (shared with other UEs) in attempting to contact an eNB, there can be a possibility of collision among multiple UEs when the multiple UEs attempt to request access using corresponding random access procedures that use respective preambles. Such random access procedures are referred to as contention-based random access procedures. Alternatively, the network can inform UE to use unique information (assigned preambles) to prevent the UE's request from colliding with requests from other UEs; this latter access that uses the assigned preamble is referred to as a contention-free random access procedure.

Within a cell, a first Zadoff-Chu base sequence can be used to define M1 (where M1>1) orthogonal preambles, based on application of respective cyclic shifts to the first base sequence. If M1 is less than 64, then one or more additional base sequences can be employed to form additional preambles, based on application of cyclic shifts to the one or more additional base sequences.

In accordance with some implementations, one or more base sequences or preambles can be reserved just for D2D discovery beacon transmissions. As noted above, a preamble is formed based on a base sequence and the corresponding cyclic shift applied to the base sequence. In some implementations, a set of one or more base sequences can be reserved for beacon transmissions in a given cell. Alternatively, a set of one or more preambles can be reserved for beacon transmissions in the given cell. The reserved base sequence(s) and/or preamble(s) is (are) different from the base sequence(s) and/or preamble(s) used for actual random access procedures within the given cell.

Information relating to relative timing advances and maximum delay spread can also be signaled by the eNB 204 to assist UEs in placing their detection windows, similar to that discussed above for cases where SRS transmissions are used as D2D discovery beacon signals.

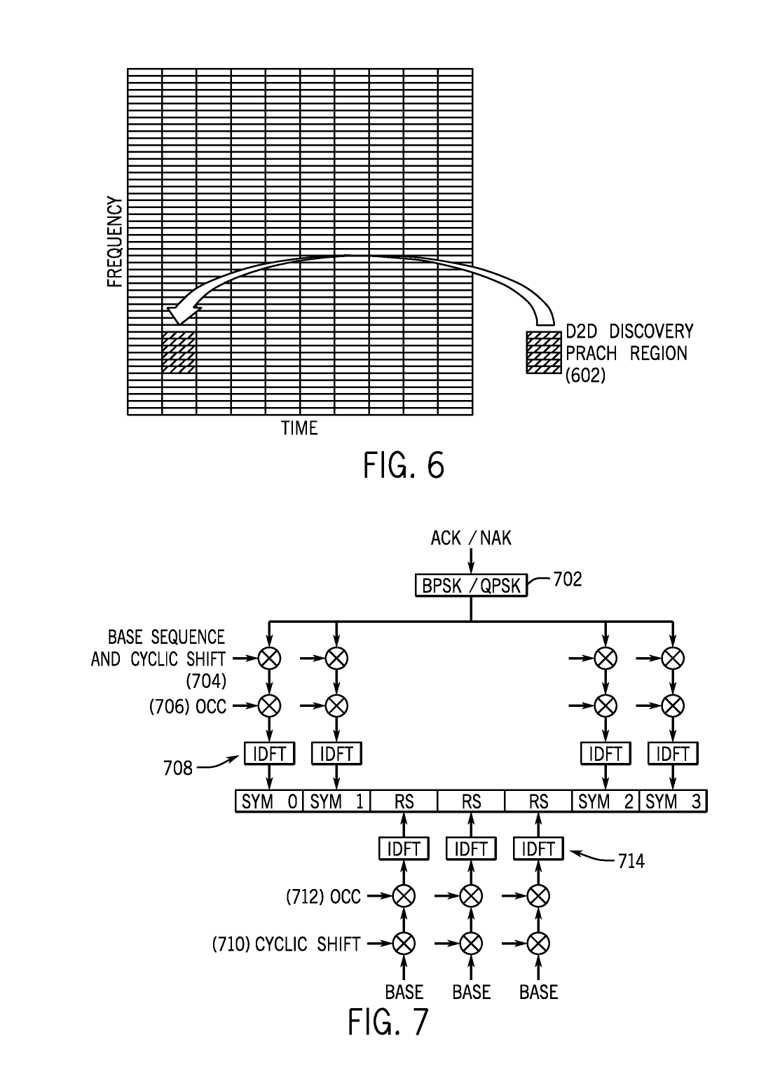

Additionally, as shown in FIG. 6, a designated PRACH region 602 (referred to as a “D2D discovery PRACH region”) can be defined to use for D2D beacon transmissions. FIG. 6 is a two-dimensional graph showing resources in a time domain and frequency domain that may be useable, if designated, for communicating PRACH signals. Each rectangle in the graph represents a respective resource block. A resource block includes a predefined number of symbols, which occupy a specified time interval along the time domain, and the resource block is provided on a respective subcarrier along the frequency domain. Multiple PRACH regions can be defined along the time-frequency axes. A PRACH region can be made up of a specific number of resource blocks (e.g. six resource blocks). The D2D discovery PRACH region 602 is used to communicate D2D beacon signals, while another PRACH region in the time-frequency domains can be used to communicate PRACH signals for traditional purposes, including random access procedures and round-trip delay measurements.

In the D2D discovery PRACH region 602 allocated just for D2D beacon transmissions, larger cyclic shifts can be used in the PRACH region to mitigate ambiguity between D2D beacons using a given base sequence. Larger cyclic shifts refer to application of different cyclic shifts to at least one base sequence, where the difference in successive cyclic shifts is larger than the difference in successive cyclic shifts used in a PRACH region used for traditional purposes. For example, in the D2D discovery PRACH region 602, successive cyclic shift i and cyclic shift j can be applied to a base sequence to produce respective preambles. In another PRACH region used for traditional purposes, successive cyclic shift x and cyclic shift y can be applied to a base sequence of the other PRACH region. The difference between cyclic shift i and cyclic shift j is larger than the difference between cyclic shift x and cyclic shift y.

In an E-UTRA network, the eNB 204 can signal information relating to the D2D discovery PRACH region 602 using an additional prach-ConfigurationIndex, which is an index that identifies the configuration of the D2D discovery PRACH region 602. This additional prach-ConfigurationIndex can be referred to as“prach-ConfigurationIndexProximity,” for example. The resources indicated by prach-ConfigurationIndexProximity can be chosen such that its subframes and/or preambles are different from those the UE is signaled within the configuration identified by the normal prach-ConfigurationIndex.

In some implementations, the eNB 204 can inform a UE of parameters for the D2D PRACH transmissions, including one or more of the following (some of which are the same as those signaled for D2D SRS transmissions):
Base sequence index;
Preamble Index (to identify the preamble of the D2D PRACH transmission);
Cyclic shift spacing;
Cyclic shift index;
Timing advance of a transmitting UE;
Timing advance of a receiving UE;
Maximum delay spread that should be expected by a receiving UE;
Time resources of beacon transmission; and
Frequency resources of beacon transmission.

Mitigation Solutions for Cyclic Shift Multiplexing Ambiguity When Using PUCCH for D2D Discovery Beacon Signal Techniques

In further alternative implementations, PUCCH signals can be used for D2D beacon transmissions. Techniques for resolving cyclic shift multiplexing ambiguity for beacon PUCCH transmissions can use techniques similar to those discussed above for beacon SRS transmissions. For example, different base sequences can be assigned to different UEs for beacon PUCCH transmissions.

A demodulation reference signal (DMRS) can be transmitted in the PUCCH. The DMRS is a reference signal for the PUCCH, and an eNB measures DMRS to be able to decode control information in the PUCCH. The location of the DMRS in the PUCCH depends on which of multiple formats of PUCCH is used. For example, PUCCH format 1/1a/1b is shown in FIG. 7, which has four symbols (Sym 0, Sym 1, Sym 2, and Sym 3) for carrying PUCCH control information, including ACK/NAK and so forth (as discussed further above). The remaining symbols (labeled “RS”) are used for carrying DMRS.

In some implementations, the DMRS can be used as a D2D discovery beacon signal. Orthogonality of PUCCH signals of different UEs can be achieved by a combination of cyclic shifts (in the frequency domain) and Single Carrier Frequency Division Multiple Access (SC-FDMA) symbol spreading (in the time domain) with orthogonal spreading code, called orthogonal cover codes (OCCs). FIG. 7 shows application of cyclic shifting and OCCs to control signaling for the different symbols of PUCCH according to the depicted format.

In the example of FIG. 7, the symbols (Sym 0, Sym 1, Sym 2, and Sym 3) are used to carry ACK/NAK information, which is subjected to binary phase shift keying (BPSK) or quadrature phase shift keying (QPSK) modulation (702), and respective application of base sequence cyclic shifting (704) and OCCs (706). An inverse discrete Fourier transform (IDFT) (708) is applied to each respective control signaling to derive the respective symbol.

Each DMRS is derived from a respective base sequence onto which cyclic shifting (710) and OCC (712) are applied, followed by an IDFT (714).

The locations of DMRS are different for other PUCCH formats.

The base sequences for each cell can be selected to reduce or minimize intra-cell interference due to multiple base sequences in a cell.

Furthermore, cyclic shifts for an adjacent orthogonal cover codes may be staggered, thus separating channel estimates before de-spreading the orthogonal cover codes. The number of base sequences assigned to each cell may be configured by higher protocol layers or may be coordinated among the cells.

If the same base sequence is used for different UEs in the same cell, either even or odd numbered cyclic shifts can be assigned to PUCCH signals of the different UEs to mitigate cyclic shift multiplexing ambiguity. Similar to the example in FIG. 4B where time regions 402-0, 402-2, 402-4, and 402-6 out of eight cyclic shift time regions (402-0 to 402-7) correspond to even numbered cyclic shifts and time regions 402-1, 402-3, 402-3, and 402-7 correspond to odd numbered cyclic shifts, twelve cyclic shift time regions on DMRS can be assigned to different UEs.

In alternative examples, instead of using either even or odd numbered cyclic shifts, all cyclic shifts can be used if a channel is separable (in other words, the issue of the D2D discovery beacon signals from different UEs arriving in the same detection window can be avoided, such as by use of various techniques discussed above).

Use of OCCs in the time domain (in addition to cyclic shifts in the frequency domain) for distinguishing PUCCH signals of different UEs allows for use of different orthogonal sequences in the time domain for different UEs. Use of the OCCs can improve D2D discovery beacon signal detection performance in cases of time mismatch of arrival times of D2D discovery beacon signals from different transmitting UEs.

As with use of SRS and PRACH signals as D2D beacon discovery signals, an eNB can signal various parameters, including relative timing advance information and other information, to UEs involved in D2D communications.

To use PUCCH for D2D discovery, a receiving UE has to know both the PUCCH configuration information but also the location of PUCCH. In some examples, the location of the PUCCH is implicitly signaled using the Physical Downlink Control Channel (PDCCH). For example, the PUCCH resource index can be implicitly determined based on an index of a first control channel element of a downlink control assignment on the PDCCH.

Power Control Issues

Power control is performed for various signals, including SRS, PRACH signals, and PUCCH signals, which are useable as D2D discovery beacon signals in addition to traditional purposes of these signals. Generally, power control for a signal can be a function of the pathloss between a UE and an eNB. As a result, UEs that are closer to the eNB will typically transmit at a lower transmit power than those UEs that are farther from the eNB. Setting the transmit power of a D2D discovery beacon signal as a function of pathloss between the beacon-transmitting UE and its serving eNB can result in issues in proper detection of D2D discovery beacon signals, since the distance between the beacon-transmitting UE and the serving eNB is likely to be different from the distance between the beacon-transmitting UE and a beacon-receiving UE.

In some implementations, a power control formula for SRS as defined by current 3GPP standards is as follows:

P_{SRS,c}(i)=min{P_{CMAX,c}(i),P_{SRS}_{_{—}}_{OFFSET,c}(m)+10log₁₀(M_{SRS,c})+P_{O}_{_{—}}_{PUSCH,c}(j)+α_{c}(j)·PL_{c}+ƒ_{c}(i)} (Eq. 1)

In Eq. 1, the transmit power of the SRS is the minimum selected from among the parameters in the set

{P_{CMAX,c}(i),P_{SRS}_{_{—}}_{OFFSET,c}(m)+10log₁₀(M_{SRS,c})+P_{O}_{_{—}}_{PUSCH,c}(j)+α_{c}(j)·PL_{c}+ƒ_{c}(i)}.

In the foregoing, P_{CMAX,c}(i) is the configured UE transmit power defined for subframe i for serving cell c. The parameter P_{SRS}_{_{—}}_{OFFSET,c}(m) is semi-statically configured by higher protocol layers for m=0 and m=1 for serving cell c. For SRS transmission given trigger type 0 then m=0 and for SRS transmission given trigger type 1 then m=1. The parameter M_{SRS,c} is the bandwidth of the SRS transmission in subframe i for serving cell c expressed in a number of resource blocks. The parameter ƒ_{c}(i) is the current PUSCH power control adjustment value for serving cell c. The parameters P_{O}_{_{—}}_{PUSCH,c}(j) and α_{c}(j) are parameters defined for the Physical Uplink Shared Channel (PUSCH) in serving cell c, where j=1. The parameter PL_{c} represents the downlink pathloss estimate calculated in the UE for serving cell c. The foregoing parameters are described further in 3GPP TS 36.213.

A similar power control formula can be used for other signals, such as PRACH signals.

If D2D beacon transmissions are performed using the legacy SRS or PRACH power control without modification, then UEs may not be able to properly detect the D2D beacon transmissions due to potential difference in distances between beacon-transmitting UEs and the serving eNB, and distances between beacon-transmitting UEs and a beacon-receiving UE.

Mitigation Solutions for Power Control Issues When Using SRS for D2D Discovery Beacon Signal Techniques

In accordance with some implementations, to address power control issues associated with D2D discovery beacon signals (and in particular beacon SRS transmissions), the eNB 204 is able to control the setting of a power level that should be used for D2D discovery beacon signals. In some examples, the eNB 204 can broadcast information pertaining to the power level to be used by all beacon-transmitting UEs in the cell served by the eNB 204. Beacon-receiving UEs will receive the same information, so that the beacon-receiving UEs will know what power level to expect for D2D discovery beacon signals.

In some implementations, multiple power levels can be set by the eNB 204 for different applications.

In some examples, the eNB 204 is able to configure the value of PL_{c} in the SRS power control formula of Eq. 1 above, when applied for beacon SRS transmissions. This gives the eNB 204 the ability to make each UE transmit with the same power value when sending a beacon SRS transmission in a given bandwidth (which can include a specific number of subcarriers).

Alternatively or additionally, the eNB 204 is able to configure the value of P_{SRS}_{_{—}}_{OFFSET,c}(m), when (or before) triggering each beacon SRS transmission from one or more UEs.

The foregoing parameters for controlling the power level of each beacon SRS transmission can be signaled by the eNB 204 to the affected UEs in one or more control messages sent by the eNB 204 to the UEs.

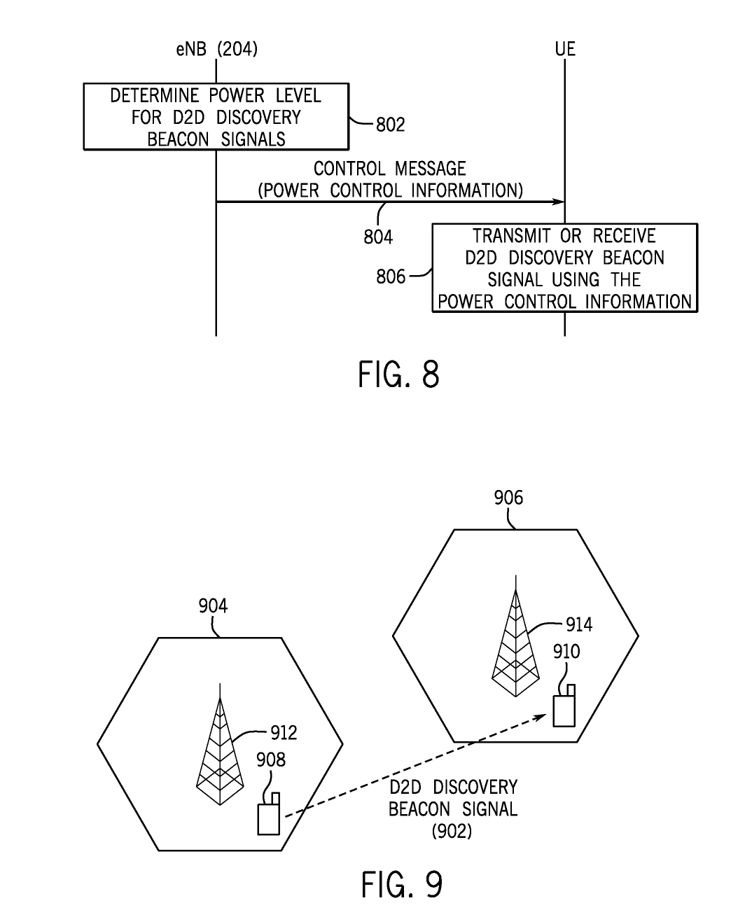

FIG. 8 depicts an example of a power control process for D2D discovery beacon signals, according to some implementations. The eNB 204 determines (at 802) a power level to use for D2D discovery beacon signals. The eNB 204 then sends (at 804) a control message to a UE, where the control message contains power control information (such as one or more parameters relating to power control as discussed above). The control message can be broadcast to multiple UEs in the cell served by the eNB 204, or the control message can be sent to just one UE. The UE can then transmit or receive (at 806) a D2D discovery beacon signal at a power level based on the power control information.

According to the 3GPP standards, the SRS transmit power is set on a subcarrier basis (i.e. each subcarrier is power controlled to a certain power level, such as expressed as X dBm/subcarrier). As a result, the total transmission power of the beacon SRS transmission can be controlled coarsely by changing the SRS transmission bandwidth. For example, an SRS transmission bandwidth of 48 resource blocks will normally involve twice the power of an SRS transmission bandwidth of 24 resource blocks. By setting the transmission bandwidths individually for each UE, the eNB 204 can attempt to achieve a somewhat coarse equalization of the transmit powers from all UEs. In such alternative implementations, the power control information sent at 704 can include the SRS transmission bandwidth.

Alternatively or additionally, the eNB 204 can set the closed-loop power control adjustment value ƒ_{c}(i) to be used for each beacon SRS transmission. For example, if the value of ƒ_{c}(i) is set to a large or infinite value, then the power level of the beacon SRS transmission would be clamped to P_{CMAX,c}(i) in Eq. 1.

If all UEs use a preset (e.g. Y dBm) transmit power value for beacon SRS transmissions, the interference at the eNB 204 may be large. If cyclic shift multiplexing is used, the eNB 204 may be able to handle the interference since the beacon SRS transmissions will be orthogonal to other signals received at the eNB 204. If different base sequences are used for the beacon SRS transmissions, the eNB 204 may reserve specific subframes for beacon SRS transmissions so that the beacon SRS transmissions are isolated from subframes where the eNB 204 in which the eNB 204 expects orthogonal signals to be able to achieve interference mitigation.

In alternative implementations where no measures are taken to eliminate the dependency of the beacon SRS transmission power level with distance from the eNB 204 (as discussed above), the eNB 204 can indicate the expected transmit power value to the beacon-receiving UE so that the beacon-receiving UE will have a reference for determining whether the received discovery beacon signal is good or bad. Alternatively, the beacon-receiving UE can report the strength of the D2D discovery beacon signal to the eNB 204, which can make the determination of the quality (good or bad) of the received discovery beacon signal.

Mitigation Solutions for Power Control Issues When Using PRACH for D2D Discovery Beacon Signal Techniques

The foregoing described various power control solutions that can be applied for beacon SRS transmissions.

In alternative implementations, power control solutions can be applied for beacon PRACH transmissions. In such alternative implementations, the eNB 204 can also set the power level that should be used for beacon PRACH transmissions, using similar techniques as discussed above, to provide both the beacon-transmitting UE and the beacon-receiving UE with the correct reference level for a beacon PRACH transmission).

According to the current 3GPP standards, power control for PRACH transmissions is according to:

P_{PRACH}=min{P_{CMAX,c}(i),PREAMBLE_RECEIVED_TARGET_POWER+PL_{c}}. (Eq. 2)

Since the current 3GPP standards specify that the maximum value for PREAMBLE_RECEIVED_TARGET_POWER is −90 dBm and the desired value of P_{CMAX,c}(i) may be around 20 dBm, a pathloss of at least 110 dB has to be present to guarantee that the UE transmits at 20 dBm. Pathloss of less than 110 dB can be common, and so it is not feasible to force the UE to transmit at high power levels.

In some implementations, a solution for setting the power level of a beacon PRACH transmission is to directly indicate the beacon transmit power to the UE using higher protocol layer signaling from the eNB 204.

In alternative implementations, to leverage existing PRACH power control procedures, another solution is to extend the expected range of values for PREAMBLE_RECEIVED_TARGET_POWER such that PREAMBLE_RECEIVED_TARGET_POWER≧P_{CMAXc}(i)−PL_{c} for all expected values of PL_{c}. For example, if a minimum pathloss of 20 dBm is assumed, and it is desirable to set P_{CMAX,c}(i)=20 dB, then the parameter PREAMBLE_RECEIVED _TARGET_POWER can be set equal to 0 dBm or some other value where the above inequality is satisfied.

In general, according to some implementations, a wireless access network node sends information affecting a power level to use by a UE for beacon signal transmissions for device-to-device (D2D) discovery.

D2D Discovery Beacon Solutions When UEs Are Served in Adjacent Cells

In some implementations, as shown in FIG. 9, the network can instruct a UE 908 in a first cell 904 to transmit a D2D discovery beacon signal 902 for receipt by a UE 910 in a second cell 906. To allow the second cell UE 910 to properly detect the discovery beacon signal 902 transmitted by the first cell UE 908, various solutions can be provided to ensure that the first cell UE 908 and second cell UE 910 are communicating a discovery beacon signal using a common set of parameters relating to the discovery beacon signal.

In a first solution, an eNB 912 of the first cell 904 can instruct the beacon-transmitting UE 908 to perform its beacon transmission with a set of parameters inherently assumed by the beacon-receiving UE 910 (or multiple beacon-receiving UEs). As an example, the beacon-transmitting UE 908 may be notified to perform its beacon transmission using the serving cell identifier of the beacon-receiving UE 910 as the virtual identifier for the beacon transmission (e.g. beacon SRS transmission). Using the serving cell identifier of the beacon-receiving UE 910 as the virtual identifier would lead the beacon-transmitting UE 908 to use parameters associated with the serving cell 906 of the beacon-receiving UE 910 to transmit the beacon SRS transmission. For examples in which beacon PRACH transmissions are used, the beacon-transmitting UE 908 may be notified of a specific base sequence (used in the cell of the beacon-receiving UE 910) to use when generating the beacon SRS transmission. In both cases, additional parameters such as time and frequency resources may be signaled.

In other examples, a default cell identifier can be assumed by the beacon-transmitting UE 908 for beacon transmissions. This default cell identifier identifies the default cell that should be assumed by the beacon-transmitting UE for a beacon transmission.

In further implementations, an eNB 914 of the second cell 906 can instruct the beacon-receiving UE 910 (or multiple beacon-receiving UEs) of parameters used by the beacon-transmitting UE 908 for the beacon transmission. The parameters can include a base sequence, cell identifier, time and frequency resources, and so forth. In such implementations, a default cell identifier can be assumed by the beacon-receiving UE for a beacon transmission.

In further alternative implementations, a new base sequence can be defined to use for beacon transmissions, such that all beacon-receiving UEs can be made aware of the transmitted base sequence. For example, additional combs can be defined to, at least partially, replace cyclic shift multiplexing. Note that the additional combs may be obtained by subdividing a single comb, such that another comb can be left untouched for backward compatible use.

The new base sequence technique can also use a default cell identifier to be assumed for beacon transmissions.

In some examples, to support D2D discovery across cell boundaries, a first eNB may provide a neighboring eNB with one or more of the following parameters:
A base sequence that should be used by a beacon-transmitting UE;
A base sequence that should be used by a beacon-receiving UE when attempting detection of a D2D discovery beacon signal;
A cell identifier of the cell that is serving the UE performing the beacon transmission;
A cell identifier of the cell that is serving the UE that is attempting to measure the beacon transmission;
Time and/or frequency resources used for the beacon transmission; and
A default or virtual cell identifier used for the beacon transmission.

To support D2D discovery across cell boundaries, an eNB may provide a UE (either served by the eNB or served by an adjacent eNB) with one or more of the following parameters:
A base sequence that should be used by a beacon-transmitting UE;
A base sequence that should be used by a beacon-receiving UE when attempting detection of a D2D discovery beacon signal;
A cell identifier of the cell that is serving the UE performing the beacon transmission;
A cell identifier of the cell that is serving the UE that is attempting to measure the beacon transmission;
Time and/or frequency resources used for the beacon transmission; and
A default or virtual cell identifier used for the beacon transmission.

In general, according to some implementations, a first wireless access network node sends, to a first UE, information relating to at least one parameter associated with beacon signal transmission between the first UE served by the first wireless access network node and a second UE served by a second wireless access network node.

Solutions to Assist in Distance Determination

In some implementations, a discovery beacon signal can be measured to estimate the distance between a beacon-transmitting UE and a beacon-receiving UE. In some examples, the beacon-receiving UE can use the location of the first ray of a power delay profile (similar to power delay profiles depicted in FIGS. 4A and 4B) to estimate the distance.

However, if the timing advance value at the beacon-receiving UE served by an eNB is different from that of the beacon-transmitting UE served by the same eNB, then an error may be introduced in the distance estimation. This error can be eliminated if a serving eNB informs the beacon-receiving UE of the timing advance value of the beacon-transmitting UE. The beacon-receiving UE can compute the difference between the timing advance value of the beacon-transmitting UE and the timing advance value of the beacon-receiving UE, and use this difference to adjust the distance computation based on the measurement of the first ray of the power delay profile corresponding to the D2D discovery beacon signal transmitted by the beacon-transmitting UE.

An alternative approach is for the beacon-receiving UE to inform the serving eNB of the location of the first ray of the power delay profile, and allow the serving eNB to use the measurement, along with the relative timing alignment values of the beacon-transmitting and beacon-receiving UEs, to determine the relative distance.

As yet a further alternative, instead of the serving eNB explicitly signaling the timing advance value of the beacon-transmitting UE to the beacon-receiving UE, the timing advance value of the beacon-transmitting UE can be implicitly determined based on which of multiple base sequences is used by the beacon-transmitting UE for the discovery beacon signal. The different base sequences can be mapped to different timing advance values. Thus, use of a particular one of the different base sequences means that the beacon-transmitting UE has a corresponding one of the different timing advance values.

In some implementations, to support distance determination between a beacon-transmitting UE and a beacon-receiving UE and/or to assist the beacon-receiving UE in setting the timing of one or more processes (for example, measurement window for discovery beacon measurement), an eNB may provide the beacon-receiving UE with one or more of the following parameters:
The timing advance value associated with the beacon-transmitting UE; and
The timing advance value that would be appropriate for other eNBs or measuring devices. One example of this is the case where two adjacent cells are not perfectly time aligned and so the timing advance value with respect to the first cell's timing has to be translated to the reference of the second cell before it is of any use to the measuring UE in the second cell.

In some implementations, to support distance determination, an eNB may request one or more of the following parameters from a beacon-receiving UE:
The measured delay of the received discovery beacon signal with respect to a reference delay. The reference delay may be the time delay associated with the starting delay for a measurement window. The measured delay can be the location of the first ray or other ray detected when performing the beacon measurement with respect to the reference delay.
The measured delay associated with transmissions from adjacent cells, eNBs, or devices with respect to a reference delay, where the reference delay can be the delay associated with the serving cell.

In general, according to some implementations, a node determines a distance between a first UE and a second UE based on a measurement by the second UE of a beacon signal transmitted by the first UE, and on a timing advance of the first UE.

Solution Relating to Measurements

UEs may report various measurements of discovery beacon signals, such as the measured signal-to-interference-plus-noise ratio (SINR) or received power level. If SRS or PRACH signals are used as discovery beacon signals, then new measurement techniques (different from existing techniques relating to CQI measurements, Reference Signal Received Power (RSRP) measurements, or Reference Signal Received Quality (RSRQ) measurements) may have to be defined. Because these new measurements can be subjected to interference from transmissions by other UEs, and because beacon discovery signals are often transmitted infrequently, the new measurements may have to be calculated differently than existing measurements. For example, since a beacon-receiving UE may not know which beacon discovery signals are used by a beacon-transmitting UE, the beacon-receiving UE may not be able to measure an unused discovery signal resource in order to determine interference and noise power without additional information.

Some implementations may use a discovery beacon interference measurement resource (DIMR), while alternative implementations may not use a DIMR.

If a DIMR is used, signaling of a higher protocol layer in an eNB can indicate one or more discovery beacon resources that a UE may assume do not contain transmitted discovery beacon signals. A discovery beacon resource can be a resource defined in the time and frequency domain, where this resource has been signalled by the eNB as useable to carry a discovery beacon signal. Such discovery beacon resource(s) that do(es) not contain transmitted discovery beacon signals can be used by the UE for the purpose of interference and noise power estimation. In other words, if the UE is informed by the eNB that a given discovery beacon resource does not contain a transmitted discovery beacon signal, then any measured quantity (power or interference level) in that given discovery beacon resource is due to noise and/or interference.

In alternative implementations, if a DIMR is not used, then a UE can determine SINR using one of various approaches. In one approach, the UE may assume that the N discovery beacon resources with the lowest power received by the UE in a given subframe contain only interference and noise power. The value of N can be set by specification or can be signaled by an eNB to the UE. The network should ensure that the N discovery beacon resources are unused.

In a second alternative when a DIMR is not used, the UE may first exclude those resources for which it reports measurements from those it will assume contains only interference and noise power, and then further assume that the remaining N′ discovery beacon resources with the lowest power received by the UE in a given subframe contain only interference and noise power. The value of N′ is determined as N′=min(N,N1-N2), where N1 is the number of discovery resources the UE receives, N2 is the number of discover resources for which it reports measurements, and N can be set by specification or can be signaled by an eNB to the UE. The network should ensure that the N discovery beacon resources are unused.

Alternatively, the UE does not have to assume that any discovery beacon resource is unused. Instead, the UE may estimate the noise and interference power within each discovery beacon resource as the mean of the lowest power levels of some number of delay bins of an estimated power delay profile calculated from the discovery beacon resource.

Given a way to compute interference and noise power for each subframe, the SINR for each subframe can be computed. In one approach, the desired signal power is calculated as the total received power in the discovery beacon resource in one subframe, and then the SINR for that subframe is the ratio of the desired signal power estimate over the interference power estimate for the subframe.

To support measurements by a beacon-receiving UE of a discovery beacon signal, an eNB may provide the beacon-receiving UE with one or more of the following:
The locations in time and/or frequency of discovery beacon resources that the UE is to report measurements upon;
The locations in time and/or frequency of beacon interference measurement resources; and
The number of discovery beacon resources transmitted within a given set of time/frequency resources; and
The transmit power used for discovery beacon signals transmitted within a given set of time/frequency resources.

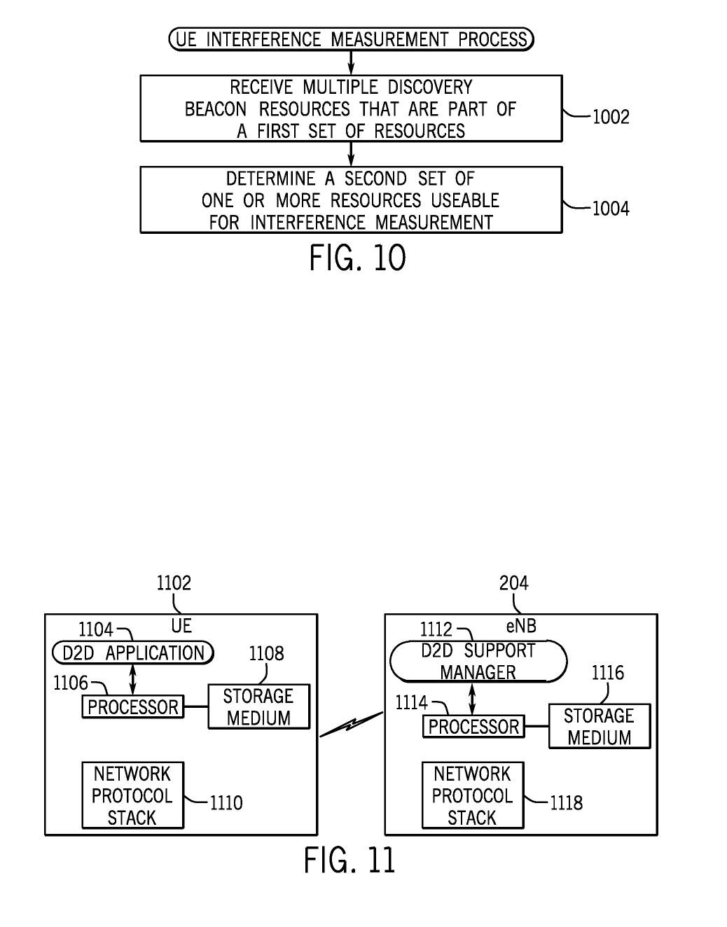

FIG. 10 is a flow diagram of an interference measurement process according to some implementations, which can be performed by a beacon-receiving UE. The beacon-receiving UE receives (at 1002) multiple discovery beacon resources, where the multiple discovery beacon resources are part of a first set of resources (e.g. time/frequency resources). The beacon-receiving UE then determines (at 1004) a second set of one or more resources that can be used for interference measurement. The second set can include one or more discovery beacon resources.

The determining (at 1004) can include any of the following:
(1) The UE receives information regarding the second set of one or more resources (e.g. location(s) in time and/or frequency of the one or more resources), where the second set can be a subset of the first set.
(2) The UE receives information regarding a number of discovery beacon resources that the UE may use to calculate the interference measurement, where the number is a number of the discovery beacon resources that are part of the first set.
(3) The UE can select the second set of one or more resources, wherein a number of discovery beacon resources in the second set is at most a specified number.

Given the ability to calculate the power of a desired signal and the noise power, it is possible to create measurement reports using a variety of measures of relative received quality of a discovery beacon signal. SINR as calculated above can be reported. Alternatively, a received signal strength such as the total received power on the desired discovery beacon resource can be reported.

In another alternative, a CQI can be reported. In this case, the error probabilities for a set of modulation and coding states (MCSs) of hypothetical transmissions on the discovery beacon resource are computed, and the MCS with maximum spectral efficiency but that has a block error rate less than a threshold is selected. The block error rate threshold may be a fixed value determined by specification, such as 10% block error rate, or it may be indicated by higher layer signalling to the UE. The index of the selected MCS is then the CQI and is reported as the relative received quality.

In yet another alternative, a discovery beacon detection error probability is reported. The discovery beacon error detection probability may be computed as described further below.

For all of these alternatives, a desired discovery beacon resource can be indicated to the UE via physical layer or higher layer signaling, or it may be known by specification.

Since measurement reports can add to signaling overhead, it may be undesirable for UEs to report measurements of discovery beacon resources that are received at low SINR. Therefore, in one approach, the UE checks that the discovery beacon received quality meets a requirement before transmitting a message such as a measurement report or a report that indicates that the UE has detected a given discovery beacon signal. The received quality requirement may be that the received SINR is greater than a threshold or that the received discovery beacon signal power is above a threshold. The SINR threshold or the received signal power threshold may be signaled to the UE using higher layer signaling or may be known by specification.

Alternatively, the received quality requirement uses a discovery beacon error probability. In this approach, the UE determines a discovery beacon detection error probability, and transmits the message if the error probability is below an error threshold. The error threshold may be signaled to the UE using signaling of a higher protocol layer or may be known by specification. The error probability may be the probability that the UE would miss detecting the discovery beacon signal, or it may be the probability that the UE would falsely detect the presence of a discovery beacon signal that was transmitted to the UE. In one approach, the UE may calculate the probability it would miss detecting a discovery beacon signal by computing the received power of a discovery beacon and the average received noise and interference power. The received interference and noise voltage is then assumed to have an a priori known probability density function (such as a Gaussian probability density function) with the average received power, and this function is used to calculate the probability that in a given subframe the noise and interference power would exceed the received discovery beacon received power. If that probability is less than the error threshold, the UE transmits the message.

Similar techniques may be used to calculate the probability of falsely detecting a discovery beacon signal.

In general, according to some implementations, a UE receives a plurality of discovery beacon resources, where the plurality of discovery beacon resources are part of a first set of resources. The UE determines a second set of one or more resources that includes one or more discovery beacon resources that may be used for an interference measurement. The determining includes at least one of:
the UE receiving information regarding the second set of one or more resources, the second set being a subset of the first set, or
the UE receiving information regarding a number of discovery beacon resources that the UE may use to calculate the interference measurement, where the number is a number of discovery beacon resources that are part of the first set, or
the UE selecting the second set of resources, the number of discovery beacon resources in the second set being at most a specified number.

In further or alternative implementations, a UE can calculate a measure of the relative received quality of a discovery beacon, where the relative received quality can include a measure of a signal power relative to interference and noise power, the signal power being calculated on a first discovery beacon resource, and the interference and noise power being calculated using the second set of resources. A message is transmitted that indicates the received quality of the discovery beacon resource.

In further or alternative implementations, the UE receives an indication that identifies a first discovery beacon resource, and the relative received quality is at least one of a signal to interference and noise power ratio, a signal to noise ratio, a channel quality indication, or a detection error probability.

In general, according to some implementations, a UE receives a discovery beacon signal. A received quality of the discovery beacon signal is determined, where the received quality is at least one of a measure of power, or a detection error probability. A message is transmitted that at least indicates that the received quality is above a threshold.

In further or alternative implementations, the received quality is at least one of a signal to noise and interference ratio, a signal to noise ratio, a received signal strength, a misdetection probability, or a false detection probability.

Conveying Information by Choice of Preamble Selection

Note that it is possible for a UE that is transmitting a discovery beacon signal to convey some amount of information to a beacon-receiving UE (or multiple beacon-receiving UEs). The conveyed information is in addition to the information of the discovery beacon signal. For example, the conveyed information can include a timing advance value, or other information. For example, if PRACH is used for discovery beacon signals, then a pool of beacon preambles can be created. A beacon-transmitting UE can select a preamble from the pool. Different information can be conveyed depending on which preamble is selected.

In some examples, a beacon-transmitting UE can indicate multiple bits of information simply by its selection of which cyclically-shifted version of a base sequence to transmit. Additional bits of information can be conveyed by selecting also among different base sequences in the pool or by selecting from different pools of time/frequency resources when performing the transmission of a discovery beacon signal.

In a more specific example where PRACH is used for beacon transmissions, up to 839 different base sequences can be employed for the beacon transmissions. In addition, each of the different base sequences can be used to generate Np (e.g. 64) different orthogonal preambles using the cyclical shifting. Assume that 64 different cyclically-shifted preambles can be created from a single base sequence. An eNB can instruct a beacon-transmitting UE to transmit any of the 64 preambles as a discovery beacon signal, and the eNB can similarly instruct one or more beacon-receiving UEs to attempt to receive each of the 64 preambles based on that base sequence. Each of the 64 preambles can correspond to a predetermined 6 bit sequence, so when a beacon-receiving UE determines that it has received a preamble, the corresponding 6 bit sequence is communicated from the beacon-transmitting UE to the beacon receiving UE. More generally, B=log2(Np) bits of information can be communicated by using a one to one association between each possible bit sequence of a B bit long sequence with each of Np discovery beacons.

Signaling Considerations

The foregoing describes various examples of information that can be communicated between a UE and an eNB for purposes of D2D discovery and/or communication. Assuming that an eNB is involved in coordinating the transmission and/or reception of discovery beacon signals, as well as possibly allocating resources for beacon discovery signals, then the eNB may send commands to UEs to indicate which UEs should be performing beacon transmissions, and which UEs should be performing beacon receptions or measurements. Also, the eNB may signal parameters that should be used by UEs for beacon transmissions and receptions, where the parameters can relate to time and frequency resources, hopping patterns, orthogonal cover codes (OCCs), transmission schemes, coding formats, and so forth.

Traditionally, in an E-UTRA network, the foregoing information may be sent by the eNB to UEs using downlink control information (DCI) messages. Multiple DCI message formats have been developed for E-UTRA to accommodate the signaling of different amounts of information and different types of information for different transmission scenarios.

A DCI message can carry downlink or uplink scheduling information as well as uplink power control commands. Each message can contain a number of fields, with each field indicating a specific type of information such as the location of the downlink or uplink resources that are being scheduled, the type of transmission mode that will be used for the transmission, and so forth. Different DCI formats can be used to convey different types of scheduling information.

Each DCI format defines a specific number of fields and the length of each field. Typically, a UE in an E-UTRA network should be capable of blindly attempting to decode a number of different DCI formats since the UE does not have complete knowledge regarding the exact type of transmission that the eNB may be sending.

Significantly increasing the number of different DCI formats for D2D discovery or communications (in addition to the traditional LTE formats) may add to the burden on mobile network devices. To avoid this issue, implementations can be provided where certain time/frequency resources are designated in advance by the eNB as being used for D2D discovery and/or D2D communications. When a UE decodes a DCI message that allocates a part of the designated D2D resources to the UE, the UE will recognize that an alternative DCI format is being employed that contains information fields useful for D2D discovery and/or D2D communications. If the DCI message does not allocate designated D2D resources to the UE, the UE will recognize that the DCI message is one that corresponds to non-D2D communication, such as an existing LTE DCI message.

Using such implementations, the number of DCI formats that the UE must decode in a subframe does not have to be increased. Instead, the same or similar blind decoding procedures as currently used can be employed, where an alternative set of DCI formats is indicated if a DCI message uses a time/frequency resource that has been designated for D2D discovery and/or D2D communication.

The indication of which time/frequency resources are designated for D2D use may be included in a message broadcast to all UEs served by the eNB. For example, the message can include a System Information Block (SIB) message, a Medium Access Control (MAC) broadcast message, or another broadcast message. The broadcast message can identify specific resources that are used for D2D purposes.

In alternative implementations, a bitmap (e.g. one-dimensional or two-dimensional bitmap) can be used to indicate which UE(s) is transmitting a D2D discovery beacon to which other UE(s). For example, a two-dimensional (2D) bitmap can have an array of bit positions, where each bit position corresponds to a respective pair of a beacon-transmitting UE and a beacon-receiving UE. For example, UEs that are capable of D2D discovery and/or communications can be indexed from 0 to M, where M (M>1) is the maximum number of UEs that are indicated as capable of D2D communications.

In an example, a column of the 2D bitmap corresponds to a respective beacon-receiving UE, while a row of the 2D bitmap corresponds to a respective beacon-transmitting UE. A value of “1” is set in a given bit position of a column of the 2D bitmap for a respective beacon-receiving UE that is to detect a beacon transmission from a beacon-transmitting UE corresponding to the row of the given bit position. A value of “0” in a bit position means that the corresponding UE does not have to perform beacon reception.

The presence of a “1” in any column of the 2D bitmap can be treated as a transmission authorization from the eNB, and resources can be allocated sequentially either using a fixed amount for each authorized UE or using an allocation vector that is linked sequentially to each row where a “1” appears. The allocation vector describes resources to allocate to each beacon-transmitting UE.

In general, according to some implementations, a first set of resources is determined for use for a first mode of transmission. A second set of resources is determined for a second mode of transmission. A downlink control information message is decoded, where the message includes information fields for resource assignment. The information fields of the message are interpreted according to a first format when the resource assignment assigns resources in the first set, and the information fields of the message are interpreted according to a second format when the resource assignment assigns resources in the second set.

System Architecture

FIG. 11 illustrates example arrangements of the eNB 204 and a UE 1102. The UE 1102 includes a D2D application 1104, which is able to perform various D2D tasks, including those discussed above. The D2D application 1104 includes machine-readable instructions executable on one or more processors 1106, which are coupled to a storage medium (or storage media) 1108. A processor can include a microprocessor, microcontroller, processor module or subsystem, programmable integrated circuit, programmable gate array, or another control or computing device.

The UE 1102 further includes a network protocol stack 1110 that is able to perform communications with the eNB 204 (as well as with nodes of the core network 210 shown in FIG. 2.

The eNB 204 includes a D2D support manager 1112, which is able to perform various tasks as discussed above relating to supporting D2D discovery and other tasks. The D2D support manager 1112 includes machine-readable instructions executable on one or more processors 1114, which are coupled to a storage medium (or storage media) 1116. The eNB 204 also includes a network protocol stack 1118 to communicate with the UE 1102.

The storage media 1108 and 1116 can be computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
assigning, by a wireless access network node, different base sequences to respective user equipments (UEs) to use for discovery beacon signals for device-to-device (D2D) discovery, wherein the discovery beacon signals include one or more of a sounding reference signal and a reference signal of a Physical Uplink Control Channel (PUCCH).

2. The method of claim 1, further comprising:
sharing, by the wireless access network node, the base sequences useable by the wireless access network node with another wireless access network node.

3. The method of claim 1, wherein the base sequences used by the wireless access network node is different from base sequences used by another wireless access network node for D2D discovery.

4. The method of claim 1, further comprising:
coordinating, by the wireless access network node with another wireless access network node, resources used for D2D discovery.

5. The method of claim 1, further comprising:
assigning, by the wireless access network node, different frequency combs to the UEs to use for the discovery beacon signals.

6. The method of claim 1, further comprising:
sending, by the wireless access network node to a particular one of the UEs, timing advance information of at least another UE.

7. The method of claim 1, further comprising:
sending, by the wireless access network node to a particular one of the UEs, a maximum delay spread to be expected by the particular UE in receiving discovery beacon signals from a transmitting UE.

8. The method of claim 1, further comprising:
sending, by the wireless access network node to a particular one of the UEs, an index of a cyclic shift for application to a particular one of the base sequences for a discovery beacon signal.

9. The method of claim 1, further comprising:
for at least two UEs that are assigned a common base sequence, assigning, by the wireless access network node, use of even and odd numbered cyclic shifts to the at least two UEs to use for the discovery beacon signals transmitted by the at least two UEs.

10. The method of claim 1, further comprising assigning, by the wireless access network node, different orthogonal sequences to different UEs to use for the discovery beacon signals from the different UEs.

11. A user equipment (UE) comprising:
at least one processor configured to:
receive, from a wireless access network node, an indication of a first base sequence to use for a discovery beacon signal to be transmitted or received by the UE for device-to-device (D2D) discovery, wherein the first base sequence is one of a plurality of base sequences assigned by the wireless access network node for use in D2D discovery,
wherein the discovery beacon signal includes a sounding reference signal or a reference signal of a Physical Uplink Control Channel (PUCCH).

12. The UE of claim 11, wherein the at least one processor is configured to further:
receive, from the wireless access network node, an index of a frequency comb to use for the discovery beacon signal, wherein the frequency comb is one of a plurality of frequency combs useable for discovery beacon signals.

13. The UE of claim 12, wherein the at least one processor is configured to further:
receive, from the wireless access network node, information indicating a number of the plurality of frequency combs used for discovery beacon signals.

14. The UE of claim 12, wherein the plurality of frequency combs are divided from a particular frequency comb.

15. The UE of claim 11, wherein the at least one processor is configured to further:
receive, from the wireless access network node, timing advance information of at least another UE.

16. The UE of claim 11, wherein the at least one processor is configured to further:
receive, from the wireless access network node, a maximum delay spread to be expected by the UE in receiving the discovery beacon signal from a transmitting UE.

17. The UE of claim 11, wherein the at least one processor is configured to further:
receive, from the wireless access network node, an index of a cyclic shift for application to the first base sequence for the discovery beacon signal.

18. A wireless access network node comprising:
at least one processor configured to:
reserve one or more base sequences or preambles of a random access channel to use for discovery beacon signal transmissions from UEs served by the wireless access network node for device-to-device (D2D) discovery, the reserved one or more base sequences or preambles different from base sequences or preambles used for random access procedures; and
send, to a first UE, information relating to a discovery beacon signal, the information indicating a timing advance value of a second UE, and information pertaining to one or more of a base sequence and preamble for the discovery beacon signal.

19. The wireless access network node of claim 18, wherein the at least one processor is configured to further:
send, to the first UE, additional information relating to the discovery beacon signal, the additional information selected from among an index of a cyclic shift of the discovery beacon signal, a maximum delay spread to be expected by the first UE for the discovery beacon signal, and resources for the discovery beacon signal.

20. The wireless access network node of claim 18, wherein the at least one processor is configured to further:
assign at least one random access channel region to use for the discovery beacon signal transmissions, wherein the at least one random access channel region is distinct from at least another random access channel region used for the random access procedures.
